(19) United States
(12) Patent Application Publication
(10) Pub. No.: US 2020/0290634 A1
(43) Pub. Date: Sep. 17, 2020

(54) CONTROL SYSTEM AND METHOD FOR CONTROLLING THE DRIVE AND BRAKING SYSTEM OF A MOTOR VEHICLE

(71) Applicant: BCS AUTOMOTIVE INTERFACE SOLUTIONS GMBH, Radolfzell (DE)

(72) Inventors: TIMO SCHUBERT, Radolfzell (DE); SOEREN LEMCKE, Radolfzell (DE)

(21) Appl. No.: 16/799,911

(22) Filed: Feb. 25, 2020

(30) Foreign Application Priority Data
Mar. 15, 2019 (DE) 102019106695.6

(51) Int. Cl. B60W 50/08; B60W 10/20; B60W 10/18; B60W 10/04

(52) U.S. Cl. CPC B60W 50/08; B60W 10/20; B62D 1/12; B60W 10/04; B60W 10/18

(57) ABSTRACT

A method for controlling a drive system and a braking system of a motor vehicle uses a motor vehicle control system with a controller component to which a control element that can be actuated by a driver is attached. Further, a sensor is provided which detects the position of the control element, and a control circuit, which receives a signal from the sensor and can convert this into an activation signal for a drive system and for a braking system of a motor vehicle. A starting position of the control element is assigned a braking signal. A first position following the starting position is assigned a neutral signal. A second position following the first position is assigned a drive signal.

The invention relates to a control system and a method for controlling the drive and braking system of a motor vehicle.

### BACKGROUND OF THE INVENTION

In many motor vehicles movement in the forward and reverse direction is controlled by two control components, in particular an accelerator pedal and a brake pedal. One control component is connected to the drive system and the other control component is connected to the braking system of the motor vehicle. In addition, motor vehicles typically have a further control component, in particular a steering wheel, in order to control the lateral movement of the motor vehicle.

The object of the invention is to provide a control system as well as a method for controlling the drive system and the braking system of a motor vehicle, with which it is made easier to control the movement of the motor vehicle in the forward and reverse direction.

### BRIEF DESCRIPTION OF THE INVENTION

The object is achieved by a motor vehicle control system with a controller component, to which a control element that can be actuated by a driver is attached, a sensor which detects the position of the control element, and a control circuit which receives a signal from the sensor and can convert this into an activation signal for a drive system and for a braking system of a motor vehicle, wherein a starting position of the control element is assigned a braking signal, a first position following the starting position is assigned a neutral signal and a second position following the first position is assigned a drive signal. The invention also provides a method for controlling the drive system and the braking system of a motor vehicle by means of the following steps:
a sensor requests the position of a control element,
if the control element is in a braking position, a control circuit which is connected to the sensor generates a braking signal,
if the control element is in a neutral position beyond the braking position, a control circuit generates a neutral signal,
if the control element is in a drive position beyond the neutral position, the control circuit generates a drive signal.

By “drive signal” is meant according to the invention a control command of the control circuit to the drive system, in particular the engine. Thus, a drive signal has the result, for example, that the motor vehicle moves from a stop to forward or reverse movement by engine power. A drive signal is accordingly also needed if the car is moving at a constant speed or if the speed is increasing. The force exerted to move the motor vehicle forward by the drive system is called the driving action. This is limited by a maximum value.

According to the invention a “braking signal”, analogously to the definition of a drive signal, is a control command of the control circuit to the braking system of the motor vehicle. By braking system is meant generally a system built into the motor vehicle, the action of which results in the reduction in the speed of the motor vehicle and/or prevents the motor vehicle from rolling away when stopped. Accordingly, for example, the built-in disc brakes and electromotive brakes in motor vehicles are a braking system according to the invention. The force exerted by the braking system is called the braking action and is limited by a maximum value.

According to the invention, the term “neutral signal” is used if the drive system does not generate a driving action and the braking system does not generate a braking action. Accordingly, for example, it is possible for the motor vehicle to roll with a neutral signal.

The invention is based on the fundamental idea that the two control components for controlling the drive system and the braking system are replaced with a single control element. The control element has a movement direction with the result that the control element can be moved into a starting position and into a final position. A sensor recognizes the positions between the starting and final positions. The control circuit allocates the position of the control element to a braking position, a neutral position or a drive position. These positions correspond to signals for the drive system and the braking system of the motor vehicle. In order to improve the convenience of the control, the control element is connected to the controller element for controlling the lateral movement of the motor vehicle.

The invention thus makes it possible to control the motor vehicle in the forward and reverse direction cost-effectively and easily through the reduction of the control components.

According to an embodiment of the invention, the controller component can be a joystick which is connected to a sensor for controlling the driving direction. This embodiment makes it possible to operate the dynamics of the motor vehicle intuitively in all movement directions with one hand.

According to an embodiment of the invention, the control element can be a button which is attached to the controller component in a translationally and/or rotationally adjustable manner. An easy control of the motor vehicle along in the forward and reverse direction with one finger is thus possible.

According to the invention the control element can comprise an adjustment travel over which the braking signal returns from a maximum braking action to a braking action of 0% at the transition to the neutral position. The braking action of the braking system can thus be metered over the adjustment travel. In particular, the braking action and thus the deceleration of the motor vehicle can be controlled.

According to an embodiment of the method, it is provided that the neutral position does not correspond to a position of the control element, but can extend over a range of different positions of the control element following on from one another. It is very difficult to reach and hold a defined position of the control element with one finger. A range of positions of the control element over which the neutral position extends therefore makes it easier to operate the motor vehicle. A controlled rolling of the motor vehicle is possible with this design.

In principle, it is possible for the drive position to be able to extend over an adjustment travel different from zero. Over this adjustment travel, the driving action can rise from 0% at the transition between neutral position and drive position to the maximum driving action in the case of maximum adjustment of the control element. Through a continuous transition between neutral position and drive position, a jerky start-up of the motor vehicle, among other things, is prevented. In addition, a metering of the driving action is possible through the adjustment travel.

According to a variant of the method, it is provided that the drive signal and the braking signal can change proportionally with the adjustment travel of the control element. This design makes a predictable control of the motor vehicle possible. A controlled adjustment of the control element thus makes it possible to increase or reduce the braking and/or driving action in a controlled manner.

Alternatively, the drive signal can change non-proportionally with the adjustment travel of the control element. A conceivable design would be, for example, that the driving action increases exponentially with the adjustment travel. Thus, at the start of the adjustment travel a range forms in which a comparatively large movement of the control element corresponds to only a small increase in the driving action. Thus, for example, a controlled driving of the motor vehicle into and out of a parking space is possible.

According to a variant of the method, it is provided that the braking signal can change non-proportionally with the adjustment travel of the control element. It can be advantageous, for example, for the braking action to change depending on the adjustment speed of the control element. A rapid adjustment of the control element could, for example, result in an abrupt braking of the motor vehicle and a slow movement of the control element could result in a gentle braking. This response increases the safety of the motor vehicle as the braking action of the braking system can thus be increased situationally and any danger situations can be reacted to in good time.

According to the invention it is also provided that the conversion of an adjustment of the control element into a braking signal or a drive signal can be different depending on the driving condition of the motor vehicle. Accordingly, for example, the ranges of the braking position, the neutral position and/or the drive position could alter depending on the driving condition and/or speed of the motor vehicle. An intelligent control allows the greatest possible driving comfort and provides the greatest safety for the motor vehicle in a wide variety of situations.

### BRIEF DESCRIPTION OF THE DRAWINGS

The invention is described below with reference to an embodiment which is represented in the attached drawings. In the drawings,

FIG. 1 schematically shows a motor vehicle control system according to the invention;

FIG. 2 schematically shows the method for controlling the drive system and the braking system of the motor vehicle; and

FIG. 3 schematically shows the curve of the drive signal and the braking signal depending on the adjustment travel of the control element.

### DETAILED DESCRIPTION OF THE INVENTION

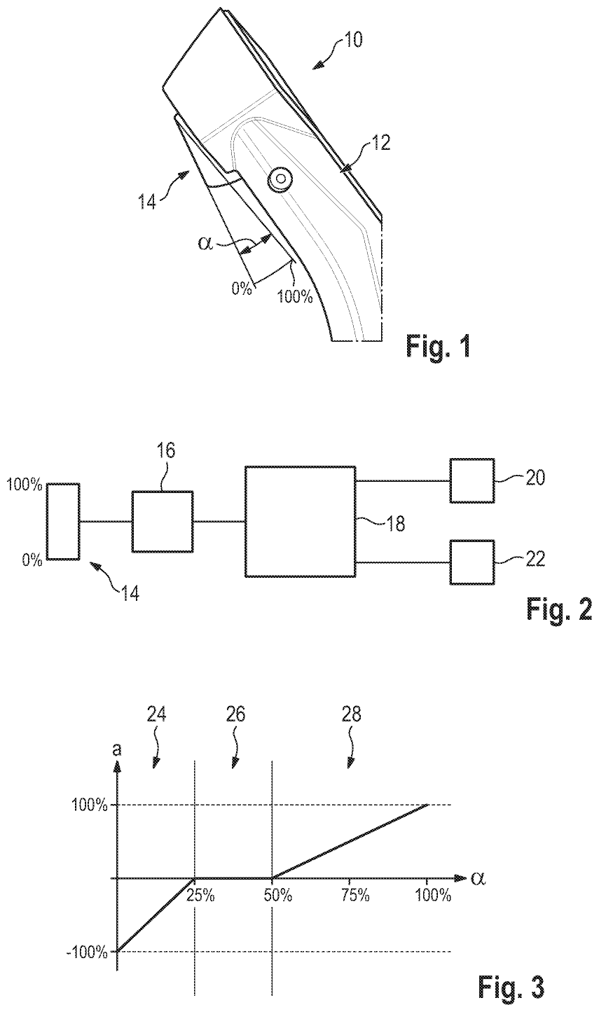

A motor vehicle control system 10 according to the invention which comprises a controller component 12 and a control element 14 is represented in FIG. 1. The controller component 12 is represented as a joystick in this embodiment. The controller component 12 is moveable in at least one dimension and serves to steer the motor vehicle.

In particular, a swivelling movement of the front and/or rear wheels of the motor vehicle can be connected to the movement of the controller component 12.

In the embodiment according to the invention according to FIG. 1, the control element 14 is designed as a button which can be moved in a swivelling manner over the angle α. In this case, the adjustment travel is to be understood as a circular arc, which results when the control element 14, which has a particular pivot point, is moved over the angle α.

It is also conceivable for the control element 14 to be formed as a button which can be moved translationally over a certain path. The distance between the starting position and the final position is then the maximum adjustment travel.

In addition, the control element 14 is attached to the controller component 12 such that the control element 14 can be actuated with one finger.

This embodiment makes it possible to control the motor vehicle, i.e. to control the movement in the forward and reverse direction and the lateral movement by steering, with only one hand. In this case, the palm of the hand controls the controller component 12 and thus the steering movement of the motor vehicle. The control element 14 can then be actuated, for example, with the index finger.

The position of the control element 14 is recognized by a sensor 16 and a corresponding signal is transmitted to the drive system 20 and/or the braking system 22 with the aid of a control circuit 18.

FIG. 2 describes, schematically, the method for controlling the drive system 20 and the braking system 22 of the motor vehicle. The positions of the control element 14 between the starting position (0%) and the maximum adjustment travel (100%) are detected by a sensor 16 and transferred to the control circuit 18.

The position of the control element 14 can be assigned to a braking position 24, a neutral position 26 or a drive position 28.

The separated representation between the control element 14, the sensor 16 and the control circuit 18 in FIG. 2 does not mean that these cannot be built in together or formed as one component. Thus, the sensor 16 could, for example, be integrated in the control circuit 18 or the control element 14 could convert the movement directly into an electrical signal and relay this to the drive system 20 or the braking system 22.

After the position of the control element 14 has been detected, the control circuit 18 sends a corresponding braking signal to the braking system 22 if the control element 14 is in the braking position 24.

If the control element 14 is in the drive position 28, the control circuit 18 sends a drive signal to the drive system 20.

In the neutral position 26, the control circuit 18 does not send a signal either to the drive system 20 or to the braking system 22.

FIG. 3 shows a schematic design of the braking signals and drive signals as a function of the adjustment travel of the control element 14. It is to be seen that the braking action falls from 100% at 0% of the adjustment travel to a braking action of 0% at 25% of the adjustment travel. This first range is to be understood as the braking position 24 of the control element 14.

Following the braking position, there is a further position, namely the neutral position 26, in which the control circuit 18 does not transfer either a drive signal to the drive system 20 or a braking signal to the braking system 22. This range is comparable, for example, to the idle position of current motor vehicles.

If the control element 14 is moved still further along the adjustment travel, the control element 14 reaches the drive position 28. In the drive position 28 the control circuit 18 activates the drive system 20. In this position, in particular, a movement of the motor vehicle in the forward or reverse direction is possible.

The values and positions represented for the braking position 24, the neutral position 26 and the drive position 28 are to be understood only by way of example. The braking action and/or driving action can also change non-proportionally with the adjustment travel.

In particular, it is also conceivable for the neutral position to be much smaller or larger than 25% of the adjustment travel.

Furthermore, it is also conceivable for the position of the transition from the braking position 24 into the neutral position 26 and/or the position of the transition from the neutral position 26 into the drive position 28 to change depending on the driving condition and/or speed of the motor vehicle.

It is conceivable, for example, for the drive position 28 to extend over a larger adjustment travel if the motor vehicle is moving in the forward or reverse direction.

By way of example, the effect of the movement of the control element 14 from the starting position, in which the deflection of the control element 14 is at 0%, into the position with the maximum adjustment travel, in which the deflection of the control element 14 is at 100%, on the dynamics of the motor vehicle is to be represented.

In the starting position, the braking action of the braking system 22 is at 100%, and the motor vehicle cannot move in the forward or reverse direction even under the action of external forces (e.g. due to an incline of the ground). This position is comparable to the situation when the parking and/or hand brake of current motor vehicles is activated.

If the control element 14 is moved from the braking position 24 into the neutral position 26, the braking action falls to 0% and a movement of the motor vehicle due to the action of external forces is possible. This position corresponds to the idle position of current motor vehicles.

In this position, for example, it is possible to move the motor vehicle by pushing.

During the transition from the neutral position 26 into the drive position 28, the control circuit 18 sends a drive signal to the drive system 20 and the driving action of the engine results in a movement in the forward or reverse direction.

If the control element 14 reaches the maximum adjustment travel, i.e. the control element 14 is in the final position, the motor vehicle experiences the maximum driving action by the engine.

The maximum driving action can, for example, have the result that the motor vehicle moves at the maximum speed or that the motor vehicle is accelerated up to the maximum speed.

1. A motor vehicle control system with a controller component to which a control element that can be actuated by a driver is attached, a sensor which detects the position of the control element, and a control circuit which receives a signal from the sensor and can convert this into an activation signal for a drive system and into an activation signal for a braking system of a motor vehicle, wherein a starting position of the control element is assigned a braking signal, a first position following the starting position is assigned a neutral signal and a second position following the first position is assigned a drive signal.

2. The motor vehicle control system of claim 1 wherein the controller component is a joystick which is connected to a sensor for controlling the driving direction.

3. The motor vehicle control system of claim 1 wherein the control element is a button which is attached to the controller component in a translationally and/or rotationally adjustable manner.

4. A method for controlling the drive system and the braking system of a motor vehicle by means of the following steps:
a) a sensor requests the position of a control element,
b) if the control element is in a starting position, a control circuit which is connected to the sensor generates a braking signal,
c) if the control element is in a neutral position beyond the starting position, a control circuit generates a neutral signal,
d) if the control element is in a drive position beyond the neutral position, the control circuit generates a drive signal.

5. The method of claim 4 wherein the braking position comprises an adjustment travel of the control element, over which the braking signal returns from a maximum braking action to a braking action of 0% at the transition to the neutral position.

6. The method of claim 4 wherein the neutral position extends over an adjustment travel different from zero.

7. The method of claim 4 wherein the drive position extends over an adjustment travel different from zero over which the driving action rises from 0% at the transition between neutral position and drive position to the maximum driving action in the case of maximum adjustment of the control element.

8. The method of claim 4 wherein the drive signal changes proportionally with the adjustment travel of the control element.

9. The method of claim 4 wherein the drive signal changes non-proportionally over the adjustment travel of the control element.

10. The method of claim 4 wherein the braking signal changes proportionally with the adjustment travel of the control element.

11. The method of claim 4 wherein the braking signal changes non-proportionally over the adjustment travel of the control element.

12. The method of claim 4 wherein the conversion of an adjustment of the control element into a braking or drive signal is different depending on the driving condition of the motor vehicle.
